(19) United States
(12) Patent Application Publication
(10) Pub. No.: US 2026/0071643 A1
(43) Pub. Date: Mar. 12, 2026

(54) PIN

(71) Applicant: A. Raymond et Cie, Grenoble (FR)

(72) Inventors: Julien Locatelli, Voiron (FR); Christian Friedrich, Los Osos, CA (US); Scott Dailey, Menlo Park, CA (US)

(21) Appl. No.: 19/107,416

(22) PCT Filed: Sep. 6, 2023
(86) PCT No.: PCT/EP2023/074372

§ 371 Date: Feb. 27, 2025

Related U.S. Application Data
(60) Provisional application No. 63/375,112, filed on Sep. 9, 2022.

(30) Foreign Application Priority Data
Sep. 20, 2022 (FR) FR2209488

(51) Int. Cl. F16B 19/02

(52) U.S. Cl. CPC F16B 19/02

(57) ABSTRACT

A pin comprises a metal body extending along an elongation axis between a first end and a second end, and has an upper face and a lower face opposite to the upper face. The pin includes a substantially planar central section, two intermediate sections each extending laterally from the central section and in a diverging manner with respect to each other, and so as to allow the stacking of at least two pins in a stacking direction perpendicular to the central sections of the pins, and latching means arranged on both of the two intermediate sections and configured to hold the pins together in pairs by latching when they are stacked.

### CROSS-REFERENCE TO RELATED APPLICATIONS

This application is a national phase entry under 35 U.S.C. § 371 of International Patent Application PCT/EP2023/074372, filed Sep. 6, 2023, designating the United States of America and published as International Patent Publication WO 2024/052368 A1 on Mar. 14, 2024, which claims the benefit under Article 8 of the Patent Cooperation Treaty of U.S. Patent Application Ser. No. 63/375,112 , filed Sep. 9, 2022, and of French Patent Application Serial No. FR2209488, filed Sep. 20, 2022.

### TECHNICAL FIELD

The present disclosure relates to a pin, in particular, for retaining elements in a rail. It is more particularly used to secure the frame of a photovoltaic module in a rail of a supporting structure.

### BACKGROUND

Most photovoltaic modules include a metal frame, in particular, an aluminum frame, arranged around the periphery of the module. This metal frame, in addition to mechanically stiffening the photovoltaic module, also enables the latter to be fastened to a metal rail, such as a steel rail, of a load-bearing structure.

When securing the metal frame of the photovoltaic module on the rail of the supporting structure, it must be taken into account that, once installed, the module may be subjected to significant loading, for example, from the forces exerted by the wind, in particular, the module being pulled out of the rail, thus tending to separate the frame of the module from the supporting structure. Whatever the conditions to which a module is subjected, the frame must be prevented from being detached from the supporting structure and flying away. It is also necessary to maintain uninterrupted electrical contact between the module and the supporting structure in order to keep the assembly electrically grounded.

It is all the more important to take these stresses into account if the supporting structure is associated with a mobile device that makes it possible to optimally orient the photovoltaic modules according to the position of the sun, or of any other circumstance. In particular, the inclination of the modules causes them to bend, which induces significant stresses on the device for securing the module to the rail in the direction orthogonal to the pull-out direction, which can cause the securing device to slide and disengage, and therefore cause the module to separate from the supporting structure.

The purpose of the present disclosure is to resolve at least part of the aforementioned problems by proposing a solution that, in particular, allows simple and fast securing of elements in a rail in order to form an assembly having a high resistance to the various aforementioned stresses and deformations and that makes it possible to maintain continuous electrical contact between the elements and the rail.

### BRIEF SUMMARY

The purpose of the present disclosure is achieved by a pin comprising a metal body extending along an elongation axis between a first end and a second end, and having an upper face and a lower face opposite to the upper face, the pin comprising:
a substantially planar central section,
two intermediate sections each extending laterally from the central section and in a diverging manner with respect to each other, and so as to allow the stacking of at least two pins in a stacking direction perpendicular to the central sections of the pins, and
latching means arranged on both of the two intermediate sections and configured to hold the pins together in pairs by latching when they are stacked.

According to one embodiment, when two pins are stacked, the lower face of one of the two pins overlaps the upper face of the other of the two pins.

According to one embodiment, each intermediate section is extended laterally, in a lateral direction perpendicular to the elongation axis, by a side section, each intermediate section forming, with the side section that extends it, a side wing of generally concave shape through the upper face of the pin.

According to one embodiment, each side wing is perforated.

According to one embodiment, the pin comprises, from the first end to the second end, a stop portion and a main portion, each side section comprising a lateral tongue that extends from a free edge of the side section and at the stop portion, the free edges both being parallel to the elongation axis or extending convergently from the first end toward the second end.

According to one embodiment, the pin comprises a stop tongue, formed on the central section, at a stop portion downstream of the main portion in a direction from the first end toward the second end, the stop tongue extending, in a direction from the second end toward the first end, in a diverging manner relative to the upper face.

According to one embodiment, the latching means comprise at least one latching pair provided with a through-opening and a boss.

According to one embodiment, the latching means are arranged so that the through-opening of a latching pair of an intermediate section of one of two stacked pins cooperates with the boss of a latching pair of an intermediate section of the other of the two stacked pins so as to ensure the latching retention of the stacked pins.

According to one embodiment, the boss of a latching pair formed on an intermediate section is formed on the upper face and upstream of the through-opening of the latching pair considered along a lateral extension direction of the intermediate section.

According to one embodiment, the boss of a latching pair formed on an intermediate section is formed on the lower face and downstream of the through-opening of the latching pair considered along a lateral extension direction of the intermediate section.

According to one embodiment, each intermediate section comprises two latching pairs.

According to one embodiment, the pin comprises a generally beveled engagement portion at its second end.

According to one embodiment, each intermediate section comprises, at the engagement portion, two planar fins that are folded inwards so as to give the engagement portion its beveled shape.

According to one embodiment, the engagement portion comprises a planar section inclined relative to the central section so as to give the engagement portion its beveled shape, the planar section extending from the central section toward the second end and being connected laterally to the intermediate sections.

According to one embodiment, the metal body is made of hardened steel.

The invention also relates to a set of pins according to the present disclosure, the pins being stacked in a direction perpendicular to the central section, and mechanically held together two by two.

### BRIEF DESCRIPTION OF THE DRAWINGS

Other features and advantages of the present disclosure will emerge from the following detailed description of example embodiments of the present disclosure with reference to the appended figures, in which:

FIG. 1 is a schematic representation in perspective view of a pin, according to the present disclosure, in particular, the pin being oriented so that its upper face can be observed;

FIG. 2 is a schematic side view of the pin shown in FIG. 1;

FIG. 3 is a schematic representation of the pin from FIG. 1; in particular, FIG. 3 is a cross-sectional representation of the pin in a plane perpendicular to the elongation axis;

FIG. 4 shows a plurality of pins stacked along a direction perpendicular to the central section of the pins;

FIG. 5 shows a latching means formed on an intermediate section; in particular, the latching means illustrated in FIG. 5 comprises a latching pair provided with a boss and a through-opening; more particularly, FIG. 5 shows a latching pair according to a first aspect;

FIG. 6 shows the latching of a first pin overlapping a second pin;

FIG. 7 shows a photovoltaic panel with secondary rails attached to its rear face;

FIG. 8 shows the first step in inserting the secondary rail into the U-shaped space of the support rail;

FIG. 9 shows a second step for securing the secondary rail in the U-shaped space of the support rail;

FIG. 10 is a representation of a variant of the pin, according to the present disclosure, the pin being mounted on a tool;

FIG. 11 is a representation of a tool dedicated to the handling of pins, according to the present disclosure;

FIG. 12 is a representation of a second example of a tool dedicated to handling pins, according to the present disclosure.

### DETAILED DESCRIPTION

For reasons of simplicity in the following description, the same references are used for elements that are identical, or that perform the same function in the different embodiments of the present disclosure.

The present disclosure relates to a pin for retaining an element in a support rail having a U-shaped cross-section. In particular, the present disclosure relates to a pin for retaining an element such as a secondary rail, secured to the rear face of a photovoltaic module, and inserted into a U-shaped rail, for example, the rail of a metal load bearing structure. In this regard, the pin is intended to be inserted along an elongation axis of the pin into openings made in side walls of the support rail and into a through-passage of the secondary rail. This assembly thus makes it possible to secure the secondary rail in the support rail.

The pin according to the present disclosure comprises a metal body extending along an elongation axis between a first end and a second end, and having an upper face and a lower face opposite the upper face.

The pin, in particular, comprises:
an essentially planar flat central section;
two intermediate sections each extending laterally from the central section and in a diverging manner with respect to each other, and so as to allow the stacking of at least two pins referred to as, respectively, first and second pins;
latching means arranged on both of the two intermediate sections and configured to hold the first pin and the second pin together by latching when they are stacked.

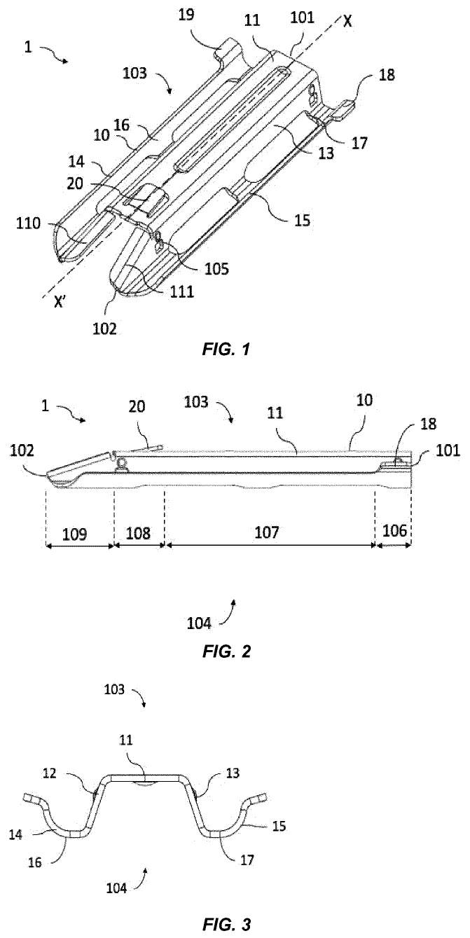

FIGS. 1-3 are different schematic representations of a pin 1 according to the principles set out in the present disclosure.

In particular, pin 1 comprises a metal body 10 that extends along a direction of elongation XX′ between a first end 101 and a second end 102.

The metal body 10 has an upper face 103 and a lower face 104 opposite to the upper face 103.

The metal body 10 consists of a metal strip. Forming the pin 1 may involve cutting, stamping or bending the metal strip.

The material of the metal body 10 is advantageously tempered steel, the shape of which is cold-formed before thermal tempering is carried out at 800° C., for example. The steel can then be protected against corrosion by way of a surface treatment step. The choice of such a material is particularly advantageous in that it allows for easy shaping before tempering, and then, after tempering, high mechanical strength and resilience.

Generally speaking, pin 1 comprises a central section 11 generally planar in shape. It is understood that central section 11 has an elongated shape along elongation axis XX′. In particular, the central section 11 has a rectangular shape and thus comprises two side edges parallel to the elongation axis XX′.

The pin 1 also comprises two intermediate sections 12 and 13. In particular, these two intermediate sections 12 and 13 each extend laterally from the central section 11 and in a diverging manner with respect to each other. It is understood that an intermediate section 12 or 13 extending laterally from the central section 11 necessarily extends from a lateral edge of the central section. More specifically, each intermediate section 12 and 13 extends from its own lateral edge. It is also understood that the two intermediate sections extend symmetrically from each other with respect to a plane perpendicular to the central section, and equidistant from the lateral edges of the central section.

It is also understood that the two intermediate sections extend in a direction parallel to the elongation axis and more particularly over a length that may be greater than the length of the side edges of the central section 11.

The increasing spacing and/or the shape of the intermediate sections 12 and 13 are, in particular, adapted to allow the stacking of a plurality of pins 1. In this respect, the intermediate sections can be planar, convex or concave at the upper face.

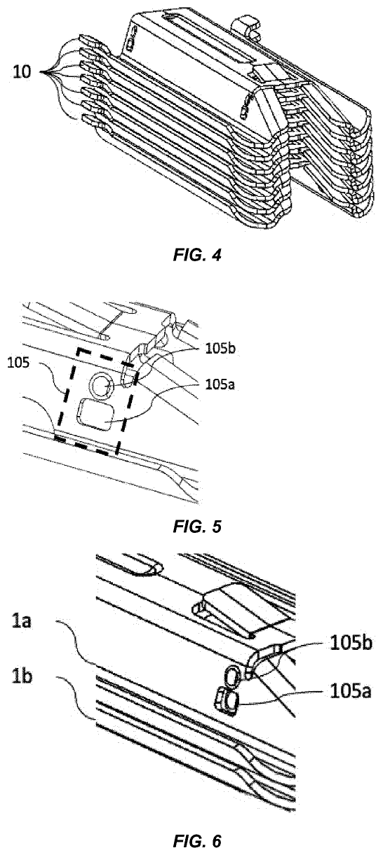

FIG. 4 shows a plurality of pins 1 stacked one on top of the other. In particular, the pins are stacked one on top of the other in a direction perpendicular to the central section 11, known as the stacking direction. By way of example, the stack may comprise two stacked pins referred to as first and second pins, respectively. More particularly, the first pin can overlap the second pin. In other words, the lower face of the first pin overlaps the upper face of the second pin.

Pin 1 also comprises latching means arranged on both of the intermediate sections 12 and 13. In particular, these latching means are configured to keep by latching the pins 1 latched together two by two when stacked.

In a particularly advantageous embodiment, the latching means comprise at least one latching pair 105 of a through-opening 105a and a boss 105b (FIG. 1 and FIG. 5). In particular, the latching means are arranged so that the through-opening 105a of a latching pair of an intermediate section of one of two stacked pins cooperates with the boss 105b of a latching pair of an intermediate section of the other of two stacked pins so as to ensure the latching retention of the stacked pins.

More particularly, and by way of example, FIG. 6 is a schematic representation of the stacking of two pins referred to respectively as first pin 1a and second pin 1b. In FIG. 6, the lower face of the first pin 1a overlaps the upper face of the second pin 1b. In addition, and still in the example shown in FIG. 6, the latching pair, referred to as the first pair, of the first pin is plumb with the latching pair, referred to as the second pair, of the second pin. In particular, in this example, for each latching pair, the boss is arranged on the upper face (and on the intermediate section), while the through-opening is located downstream of the boss in the direction of lateral extension of the intermediate section in question. In this way, latching of the first and second pins involves cooperation of the boss of the second pair with the through-opening of the first pair. This cooperation involves inserting the boss into the through-opening.

Inserting the boss into the through-opening may involve slight deformation of one of the intermediate sections of one and/or the other of the first and second pins.

Thus, in accordance with the above, and according to a first aspect relating to the latching means, the boss of a latching pair formed on an intermediate section is formed on the upper face and upstream of the through-opening of the latching pair considered along a direction of lateral extension of the intermediate section.

According to a second aspect, not shown in the figures, the boss of a latching pair formed on an intermediate section is formed on the lower face and downstream of the through-opening of the latching pair considered along a direction of lateral extension of the intermediate section.

The invention, and, in particular, the configuration of the latching means, is not limited to these two aspects, and the person skilled in the art will be able to consider other latching means. In particular, it is possible to consider a latching pair having a lug and a non-through-opening.

In a particularly advantageous embodiment, each intermediate section can be provided with two latching means.

Again advantageously, each intermediate section can be extended laterally, in a lateral direction perpendicular to the elongation axis, by a side section 14 and 15. More particularly, each intermediate section forms, with the side section that extends it, a side wing 16 and 17 of generally concave shape through the upper face 103 of the pin 1.

In a further advantageous embodiment, each side wing 16 and 17 is perforated.

Generally speaking, different portions of pin 1 can be distinguished. In particular, and as illustrated in FIG. 2, the pin 1 may comprise, from the first end 101 toward the second end 102, a stop portion 106 and a main portion 107. In particular, pin 1 may comprise lateral tongues formed on its stop portion 106. In particular, these lateral tongues act as stops when the pin is used to hold an element in a support rail. In this respect, two lateral tongues 18 and 19 (FIG. 1 and FIG. 2) can extend from a free edge of either of the side sections 14 and 15 and at the stop portion 106. These free edges can be parallel to the elongation axis or extend convergently from the first end to the second end.

Complementarily, the pin comprises a stop tongue 20, formed on the central section 11 at a stop portion 108 downstream of the main portion 107 in the direction from the first end 101 toward the second end 102. In particular, the stop tongue 20 extends in a direction from the second end toward the first end, in a diverging manner relative to the upper face 103.

Also in a complementary manner, the pin can comprise an engagement portion 109 downstream of the main portion, advantageously downstream of the stop portion, in the direction from the second end toward the first end. In particular, the engagement portion 109 has a beveled shape.

In this respect, each intermediate section comprises, at the engagement portion, two flat fins 110, 111 folded inwards so as to give the engagement portion its beveled shape.

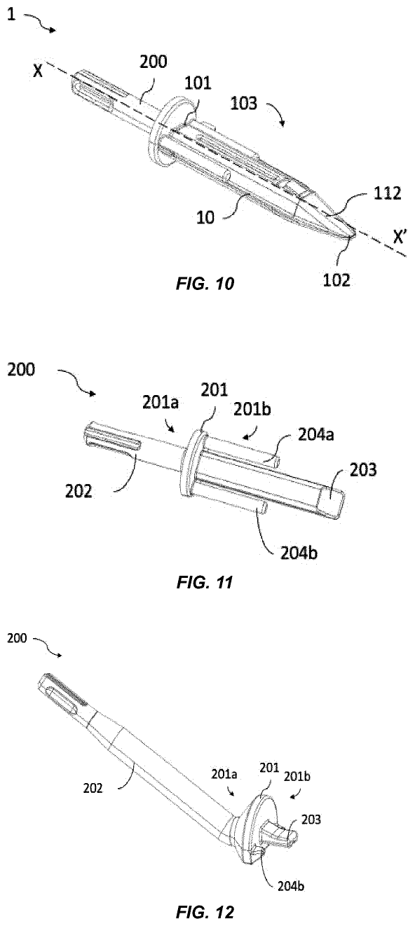

According to a variant illustrated in FIG. 10, the engagement portion 109 may comprise a planar section 112 inclined with respect to the central section 11 so as to give the engagement portion its beveled shape. In particular, the planar section 112 extends from the central section 11 toward the second end 102. In particular, the planar section 112 can be connected laterally to the intermediate sections 12 and 13.

The pin 1 is advantageously used to hold a photovoltaic module on one or more support rails.

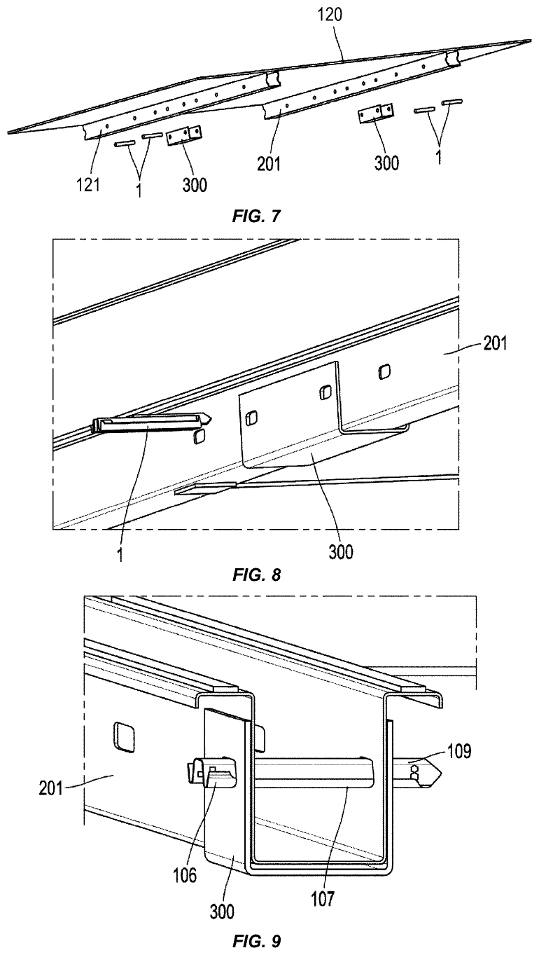

In this respect, FIG. 7 is a representation of a photovoltaic panel 120 on a rear face of which secondary rails 121 are secured. In particular, these secondary rails 121 run parallel to one another. FIG. 7 also shows support rails 300 belonging to a load-bearing structure.

The support rails 300 have a U-shaped cross-section and are thus shaped to house a secondary rail 121 in their U-shaped space. In particular, the secondary rail can be shaped to match the U-shaped gap in the support rail 300. The secondary rail and the support rail also comprise lateral through-openings to allow insertion of a pin for attaching the secondary rail to the support rail.

Thus, securing the photovoltaic panel to the load-bearing structure comprises a first step of inserting the secondary rail 121 into the U-space of the support rail 300 (FIG. 8). In particular, this insertion is carried out so that the lateral openings of the support rail and the secondary rail face each other.

This first step is followed by a second step in which the pin 1 is inserted through its engagement portion into a lateral opening in the support rail. The beveled shape of the engagement portion facilitates the engagement of the pin.

When this second step is carried out, an insertion force is exerted on the first end.

At the end of the second step (FIG. 9), the stop portion 106 abuts, by its lateral tongues 18, 19, against a lateral wall, known as the insertion wall, of the support rail 300, while the engagement portion 109 is projects relative to a wall of the support rail 300 opposite the insertion wall. The stop tongue 20 holds the pin 1 in a locked position.

A pin 1 according to the present disclosure thus enables a secondary rail to be secured to a support rail simply and securely.

In addition, taking into account the free edges of side sections 14 and 15 extending in a non-parallel manner facilitates insertion of the pin into the opening.

The present disclosure also concerns a dedicated tool for engaging the pin in the side openings. In particular, the dedicated tool 200 (shown in FIG. 11) comprises a central section 201 having two parallel faces known as first face 201a and second face 201b, respectively. For example, the central section 201 may be disc-shaped. The dedicated tool 200 further comprises a main shaft 202 extending perpendicularly from the first face 201a of the central section. In particular, the main shaft 202 is configured for mounting the tool 200 on a device (not shown).

The tool 200 also comprises a central rod 203 and two lateral rods 204a and 204b extending perpendicularly from second face 201b. In particular, the two lateral rods 204a and 204b are arranged symmetrically with respect to the central rod 203.

The use of pins may also involve the use of the dedicated tool 200. In particular, a pin 1 can be installed on the dedicated tool 200 (as shown in FIG. 10). In particular, when the pin is mounted on the tool 200, the central rod 203 is positioned against the central section 11 by the lower face, while the two lateral rods 204a and 204b are each positioned against a side wing 16, 17 by the upper face 103.

A pin can be installed on the tool using an automated loader, which includes a magazine into which a set of stacked pins is loaded.

FIG. 12 shows a second example of tool 200 for engaging a pin in the side openings.

This second example is essentially the same as the one shown in FIG. 11. However, in contrast to the previous example, the main shaft 202 comprises a bend that connects it to the central section 201, so that the shaft extends obliquely from the central section 201.

As shown in FIG. 12, the central rod 203 and the two lateral rods 204a and 204b may have lengths and shapes that are different than those shown in FIG. 11.

Of course, the present disclosure is not limited to the embodiments described and it is possible to add variants without departing from the scope of the invention as defined by the claims.

1. A pin including a metal body extending along an elongation axis between a first end of the pin and a second end of the pin, the metal body having an upper face and a lower face opposite to the upper face, the pin comprising:
a substantially planar central section;
two intermediate sections each extending laterally from the central section and in a diverging manner with respect to each other, and so as to allow stacking of at least two pins in a stacking direction perpendicular to the central sections of the pins;
latching means arranged on both of the two intermediate sections and configured to hold the pins together in pairs by latching when they are stacked; and
a generally beveled engagement portion at the second end of the pin.

2. The pin of claim 1, wherein, when two pins are stacked, one of the two pins overlaps, with its lower face, the upper face of the other of the two pins.

3. The pin of claim 1, wherein each intermediate section is extended laterally, in a lateral direction perpendicular to the elongation axis, by a side section, each intermediate section forming, with the side section that extends it, a side wing of generally concave shape through the upper face of the pin.

4. The pin of claim 3, wherein each side wing is perforated.

5. The pin of claim 3, wherein the pin comprises, from the first end to the second end, a stop portion and a main portion, each side section comprising a lateral tongue that extends from a free edge of the side section and at the stop portion, the free edges both being parallel to the axis of elongation or extending convergently from the first end toward the second end.

6. The pin of claim 5, wherein the pin comprises a stop tongue, formed on the central section, at a stop portion downstream of the main portion in a direction from the first end toward the second end, the stop tongue extends in a direction from the second end toward the first end, in a diverging manner with respect to the upper face.

7. The pin of claim 1, wherein the latching means comprise at least one latching pair provided with a through-opening and a boss.

8. The pin of claim 7, wherein the latching means are arranged so that the through-opening of a latching pair of an intermediate section of one of two stacked pins cooperates with the boss of a latching pair of an intermediate section of the other of the two stacked pins so as to ensure that the stacked pins are held by latching.

9. The pin of claim 8, wherein the boss of a latching pair formed on an intermediate section is formed on the upper face and upstream of the through-opening of the latching pair considered along a lateral extension direction of the intermediate section.

10. The pin of claim 8, wherein the boss of a latching pair formed on an intermediate section is formed on the lower face and downstream of the through-opening of the latching pair considered in a direction of lateral extension of the intermediate section.

11. The pin of claim 7, wherein each intermediate section comprises two latching pairs.

12. The pin of claim 1, wherein the metal body is made of hardened steel.

13. A set of pins according to claim 1, wherein the pins are stacked in a direction perpendicular to the central section, and mechanically held between them in pairs.

14. The pin of claim 1, wherein each intermediate section comprises, at the engagement portion, two flat fins folded inwards so as to give the engagement portion the beveled shape.

15. The pin of claim 1, wherein the engagement portion comprises a planar section inclined relative to the central section so as to give the engagement portion the beveled shape, the planar section extending from the central section toward the second end and being connected laterally to the intermediate sections.
